(19) United States
(12) Patent Application Publication
(10) Pub. No.: US 2003/0127367 A1
(43) Pub. Date: Jul. 10, 2003

(54) System for clean dining area maintenance and promoting dining establishments

(76) Inventor: Sharon Neville, Silverthorne, CO (US)

Correspondence Address: SANTANGELO LAW OFFICES, P.C., 125 SOUTH HOWES, THIRD FLOOR, FORT COLLINS, CO, 80521, US

(21) Appl. No.: 10/317,537

(22) Filed: Dec. 11, 2002

Related U.S. Application Data
(60) Provisional application No. 60/339,669, filed on Dec. 12, 2001.

(51) Int. Cl. B03B 1/00; B07B 1/00

(52) U.S. Cl. 209/1

(57) ABSTRACT

The invention comprises methods and related apparatus designed to facilitate a diner's transportation of foods from a restaurant, methods and related apparatus to maintain dining area cleanliness, and a restaurant method related to the provision and release of containers suited for containment of foods without first having the diner request such container(s). Containers used in the methods may include expressive indicia so as to promote a business entity such as a restaurant, to comport with a restaurant theme (i.e., a sports bar), or to enhance the celebration of a holiday, as but a few examples.

### CROSS-REFERENCES TO RELATED APPLICATIONS

This application claims the benefit of U.S. Provisional Application 60/339,669 filed Dec. 11, 2001 (but accorded a filing date of Dec. 12, 2001), entitled “A System for Clean Dining Area Maintenance and Promoting Dining Establishments” and hereby incorporated by reference.

### BACKGROUND OF THE INVENTION

Often, a diner may want to discard certain unwanted items while eating. These unwanted items may include the pickle a consumer may dislike that is leaking undesired juices on other food, the extra onion one may not want on their salad or the chicken bones from the Buffalo Wings, just to name a few. Often a dining table may include individually, sanitary wrapped crackers, jellies, creamers and other items whose wrappings (or foodstuff packaging waste) clutter up the open space on a table and compromise dining area sanitation. Nearly all meals served create some amount of unwanted dining items (including foodstuff packaging waste such as opened sugar packets and opened creamer packets, unwanted food items, unconsumed foods, and other dining debris), especially in social or public dining experiences, but such may also occur at a family dinner or dining table, and proper elimination of these unwanted dining items from a diner's plate, from the diner's view, or from the immediate dining area is often desired but inconvenient and interruptive (as it may require getting up from the table). Additionally, such unwanted debris compromise the sanitation and cleanliness of the dining area. It is a goal of at least one aspect of the present invention to address these problems.

Additionally, a diner may want to transport certain foodstuffs (such as scraps of food for a pet, e.g., or portions of a meal served at a restaurant, or the entire meal) to another location (usually home) for later consumption. However, the conventional manner in which a restaurant accommodates a diner's desire to get foodstuffs prepared “to-go” is often time consuming and inconvenient, as it involves a request by the diner for a “to-go” container. It is an objective of at least one aspect of the instant invention to mitigate this problem associated with dining.

### SUMMARY OF THE INVENTION

Generally this invention relates to a container or receptacle system for serving, transporting and disposing of foodstuffs and other items associated with dining in a variety of settings. It may also relate to techniques to promote and remind consumers of businesses. The container(s) referenced herein may be either disposable or reusable and may be constructed from a variety of materials such as, but not limited to, plastic, glass, ceramic, metal, rubber, paper or synthetic. It may be light, stackable and easy to store. A lid may be added to create a functional to-go container or storage container. It may also be heavy and durable, so as not to blow over or away in an outdoor setting. It may be casual or elegant depending upon its use and numerous designs. A variety of shapes, sizes and colors may be utilized and may be limited only by the imagination. Several methods related to the container(s) are also deemed part of the inventive technology.

The invention comprises methods and related apparatus designed to facilitate a diner's transportation of left-over foods from a restaurant, methods and related apparatus to maintain dining area cleanliness, and a restaurant method related to the provision and release of containers suited for containment of left-over foods without first having the diner request such container(s). Containers may include expressive indicia so as to promote a business entity such as a restaurant, to comport with a restaurant theme (i.e., a sports bar), or to enhance the celebration of a holiday, as but a few examples.

### BRIEF DESCRIPTION OF THE DRAWINGS

The following figures are merely intended as examples and are not intended to limit the scope of any coverage afforded by the claims. Further, not all expressive indicia shown on the following figures is referenced numerically.

FIG. 1 shows a left view of an apparatus having dumpster expressive indicia.

FIG. 2 shows a right view of an apparatus having dumpster expressive indicia.

FIG. 3 shows a front view of an apparatus having dumpster expressive indicia.

FIG. 4 shows a back or rear view of an apparatus having dumpster expressive indicia.

FIG. 5 shows a bottom view of an apparatus having dumpster expressive indicia.

FIG. 6 shows a top view of an apparatus having dumpster expressive indicia.

FIG. 7 shows a perspective view of an apparatus having dumpster expressive indicia.

FIG. 8 shows a bottom view of an apparatus having dumpster expressive indicia.

FIG. 9 shows a side view of an apparatus having trash-can expressive indicia.

FIG. 10 shows a top view of an apparatus having trash-can expressive indicia.

FIG. 11 shows a perspective view of an apparatus having trash-can expressive indicia.

FIG. 12 shows a bottom view of an apparatus having trash-can expressive indicia.

FIG. 13 shows a side view of an apparatus having trash-can expressive indicia.

FIG. 14 shows a top view of an apparatus having trash-can expressive indicia.

FIG. 15 shows a perspective view of an apparatus having trash-can expressive indicia.

FIG. 16 shows a bottom view of an apparatus having baseball expressive indicia.

FIG. 17 shows a top view of an apparatus having baseball expressive indicia.

FIG. 18 shows a perspective view of an apparatus having baseball expressive indicia.

FIG. 19 shows a perspective view of a container with a combined towel dispenser.

### DESCRIPTION OF THE PREFERRED EMBODIMENTS

The container receptacle or container as described in the present invention may be designed to make a dining table in any setting more enjoyable, clean, safe, sanitary and practical. The container (which may include an upper enclosure element or not, and which may be an enclosable container or not) may provide a receptacle for unwanted dining items (including used items associated with dining).

At a restaurant, the container may facilitate a diner's transportation of foodstuffs from that restaurant, as the provision of such containers in an extremely convenient position (e.g., atop a dining table), the unconditional provision of such containers atop a dining table before a dining patron (or diner) eats at the table, and the unconditional release of such containers with a dining patron(s) from a restaurant are each steps that, alone or in combination, can facilitate the otherwise often cumbersome and time consuming conventional process that a dining patron must go through in order to have left-over food prepared “to-go.” Such conventional process involves requesting that certain left-overs be boxed or contained so that they may be taken by the patron in a “to-go” form. This request is deemed a condition (as would be any request), and the relinquishment of custody or control of the container by the restaurant is deemed a release of the container. Conventionally, this release occurs after a request by a dining patron that left-over food be prepared “to-go” (i.e., it is conditional) and when the container is handed to the dining patron or set on the dining table. Importantly, when it is indicated that step may be performed by a restaurant, of course it is the employee(s) who will be performing these steps.

The method of facilitating a diner's transportation of foodstuffs from a restaurant may also comprise the step of obtaining a plurality of enclosable containers (1) and upper enclosure elements (2) and stacking them in at least on stack on a dining table before the diner eats at the table. It may also comprise the step of indicating alternative uses of the container (i.e., uses alternative to containment of foodstuffs) such as at home storage of e.g., crayons and other items. This indication of alternative uses may be accomplished by expressive indicia (3) (which may include words) established on the enclosable container (1) and or the upper enclosure element (2).

The container may be as varied as the people and food that come together. It may be as elegant as crystal and china in design, color shape or size or as rowdy as a biker bar and every thing in between. One aspect of the present invention may be to utilize a variety of container sizes to accommodate the number of people being served and the average waste produced by the dining experience. One example of the variety of container sizes that may be utilized might be high waste foods such as seafood, barbecue, and the like, that may require large open containers, while breakfast may require a taller, slimmer receptacle that takes up less space but holds an adequate amount of waste. Containers with lids may be desirable in some instances to hide the contents from view or to keep the contents from blowing out. Any shaping, sizing, construction from a certain material, or coloring (or other noticeable design feature) of the container may be termed expressive indicia (3) as long as that feature is noticeable by a diner.

It is important to understand that the term container (when used alone) is a general term that may refer to any receptacle that is capable of containing an item. The term does not require complete enclosure of contained elements, as a lid or upper enclosure element (2) is not a required part of a container (although certainly claims may include such a limit). The term enclosable container (1) implies that the container is in some manner enclosable, perhaps via use of another element such as an upper enclosure element (2). Such an upper enclosure element (2), which includes lids, tops, and even the top part of a bag whose lower part forms the enclosable container (1), may be engageable with the enclosable container (1) so that together they may enclosedly contain (as by entirely surrounding) items such as left-over foods or foods bought for take-out, or, more generally. foodstuffs, or other dining items such as dining debris. A snap-on lid or cap, or one that merely sits atop the enclosable container (1), is considered engageable with the enclosable container (1). Even the top part of a bag (such as a paper bag) may be viewed as an upper enclosure element (2) that is engageable with an enclosable container (1) (the lower part of the bag) to enclosedly contain items. Such engagement of such an upper part of a bag may be accomplished merely by reconforming the upper part of the bag (as by twisting or crumbling) so as to close the opening of the enclosable container (1).

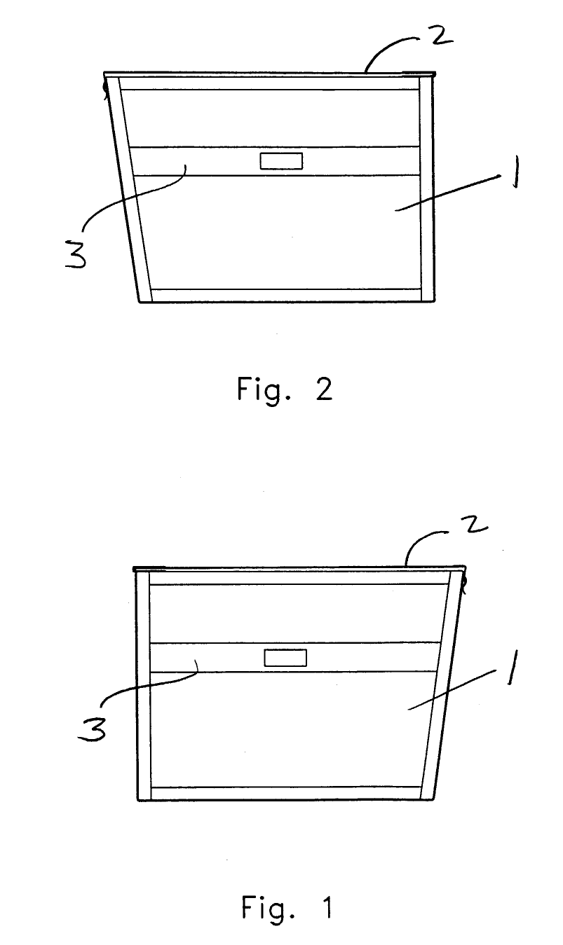

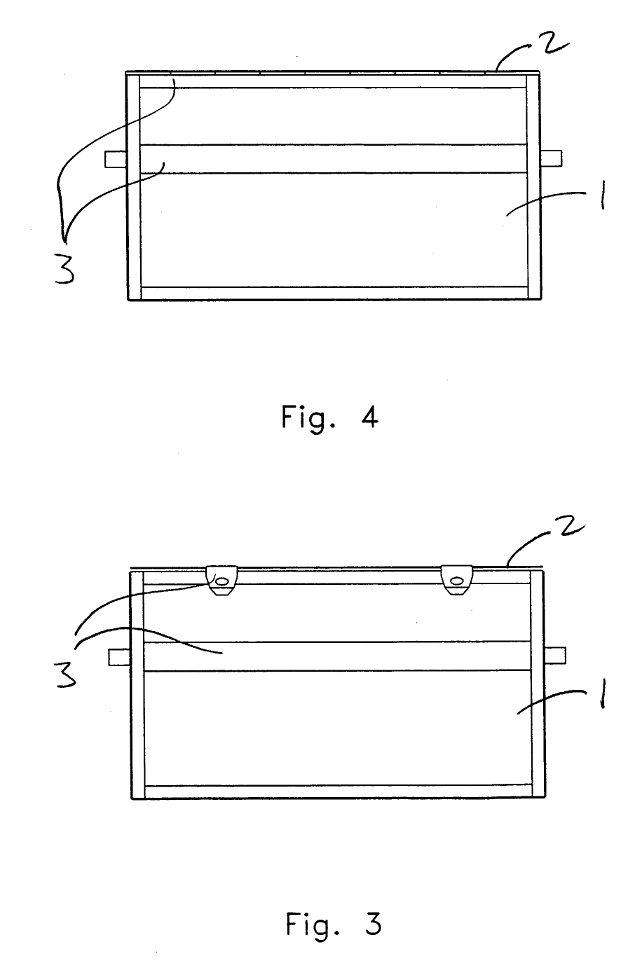

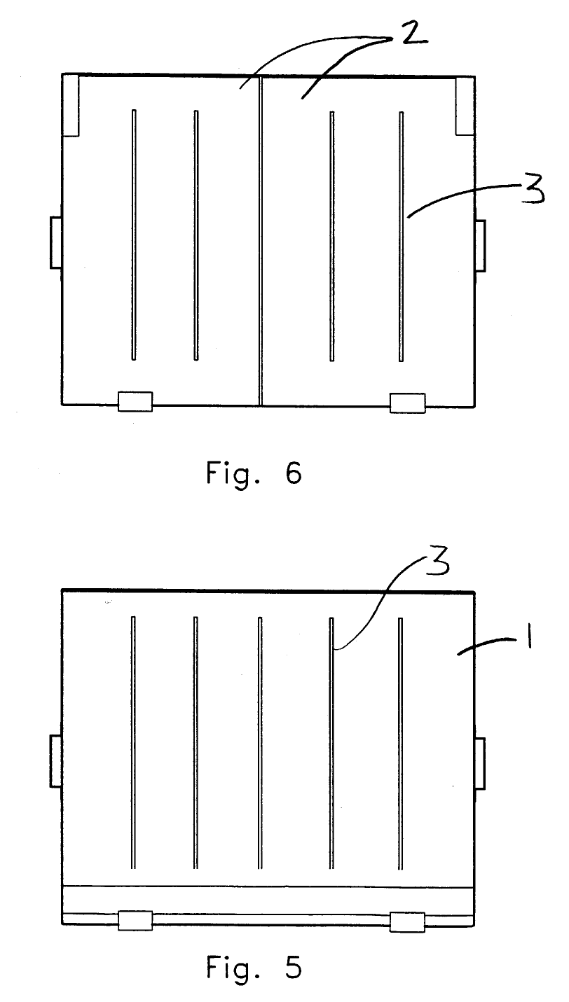

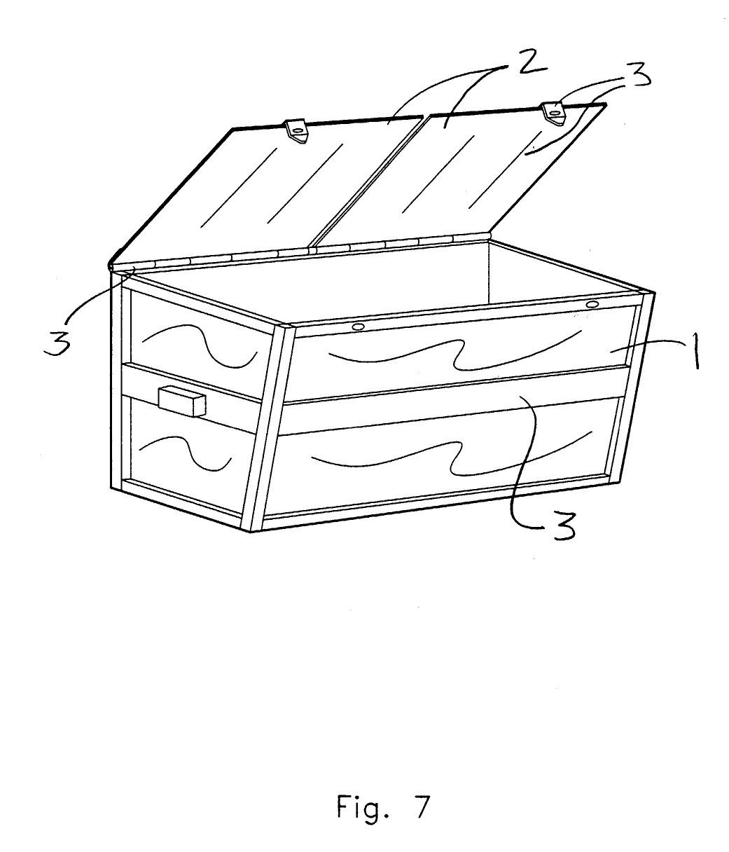

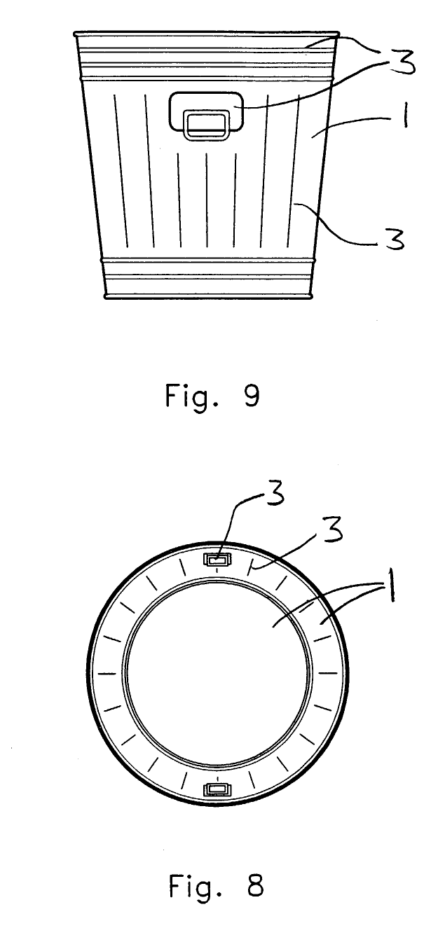

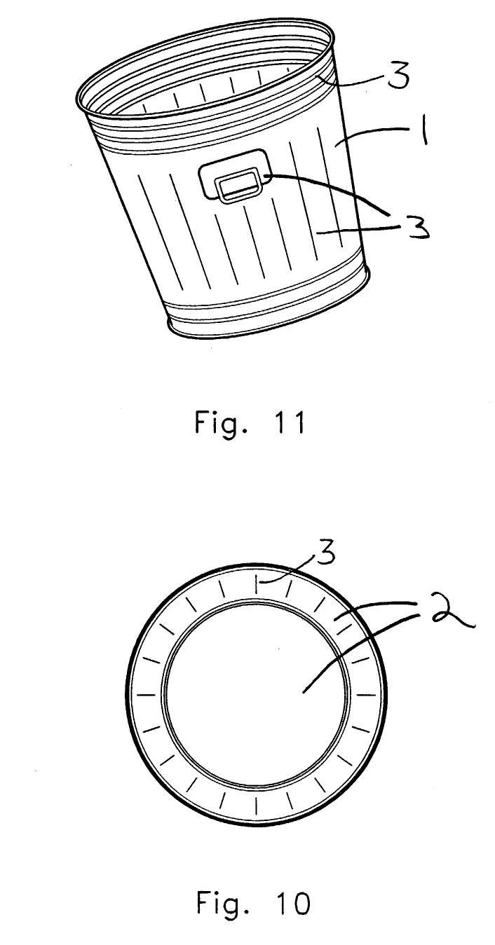

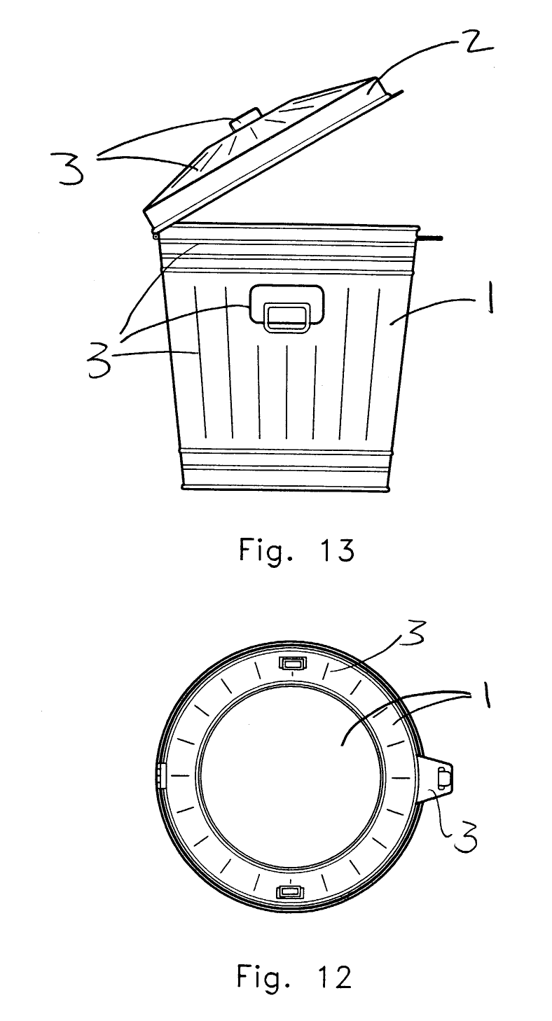

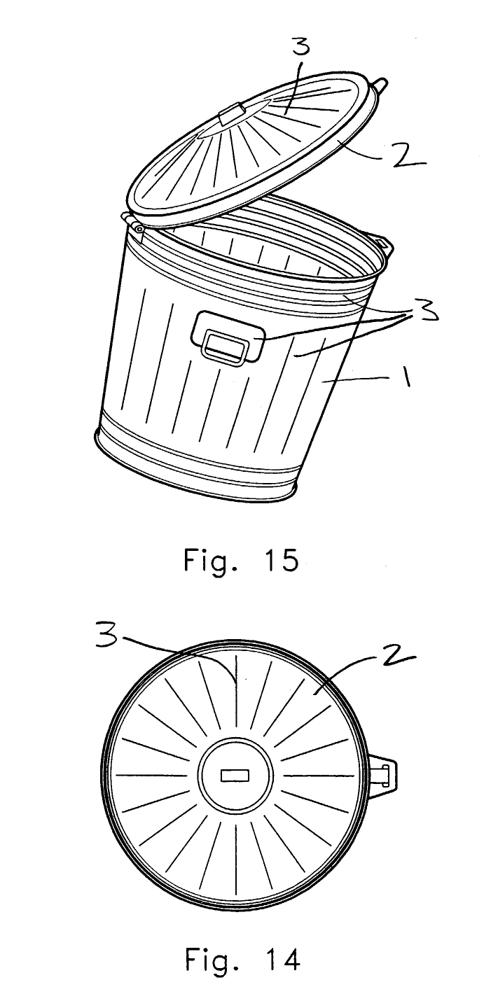

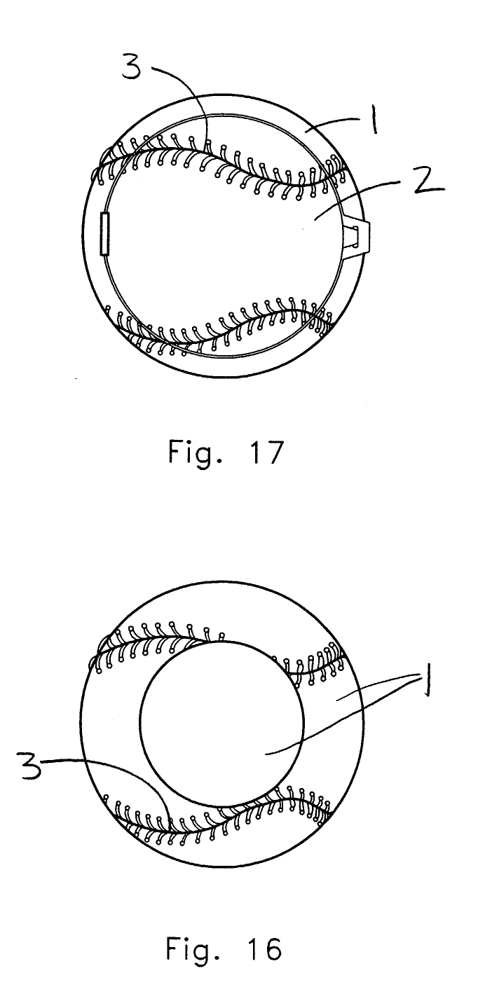

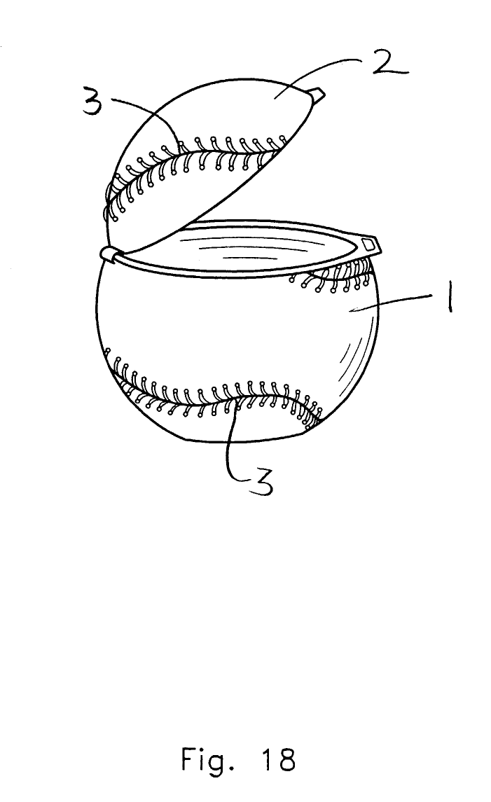

The container may also lend itself to a variety of business and novelty uses and may be designed for use for a specific occasion, restaurant, food, location, holiday or event. An example of one occasion might be a basketball championship that may utilize container units in the shape and color of basketballs. Another example may be a restaurant setting that may utilize containers in various theme shaped units, such as fish or crab shaped containers for a seafood restaurant. The name and logo of the restaurant may also be included on the container as well as some contact or location information. Yet another example may consist of a container for barbecue which may be fashioned in a large red and white checkered bowl shape. Containers for holidays are another example of the many uses of the present invention. The holiday containers, naturally, may be decorated with holiday art and may also be used as gift containers to give away holiday goodies or for display of the many holiday foods for eating. Additional containers may serve as trash receptacles. Additional settings for use of the present invention may include a variety of special events or locations, including but not limited to, weddings, anniversaries, graduations or the like. Some examples of location specific uses may be an amusement facility such as Sea World, perhaps utilizing the containers configured in the shape of a whale, a Mickey Mouse shaped container at Disneyland, or even containers in the shape of Mount Rushmore, etc. All of these design or appearance features may be termed expressive indicia (3), in addition to the design features indicated above. Any expressive indicia (3) which is intended to promote a certain entity such as a business is advertising indicia, and may be restaurant promotion indicia. As to the certain container configurations (e.g., a dumpster as in FIGS. 1-8, or trashcan as in FIGS. 9-15, or sports balls such as a basketball, baseball as in FIGS. 16-18 or football, or event such as a wedding, as but a few examples), the expressive indicia (3) may comprise shaping and marking that give the container the intended appearance (i.e., dumpster, trashcan, basketball, baseball, football, or wedding as but a few examples). Indeed, expressive indicia (3) may relate to any one or more of a food type, geographic site, season, holiday, event, amusement facility, business logo, sport, specific business entity, as but a few examples.

The container or receptacle may be designed to be clean and sanitary. A clean reusable or a new disposable unit could be used for each dining experience. The containers may keep the dining area clear of clutter and trash by providing one attractive location to dispose of all dining debris. In a restaurant environment, persons clearing and resetting dining tables may not need to handle possible germ laden items left by guests on the table such as tissues, toothpicks, partially eaten food or other items, and thus may reduce the possibility of spreading diseases or contact with body fluids. This may reduce law suits or time-off for illness. The entire dining area including the table and the room may look cleaner and tidier. With clear labeling, a purpose identifying configuration (which may be a type of expressive indicia (3)) or even minimal explanation patrons and guests may readily enjoy the convenience and use of these practical and decorative containers at their favorite dining locations.

Disposable container units with lids may be used, not only as waste receptacles, but as clean, disposable to-go containers thereby minimizing space and inventory for such items by having one multi-functional container receptacle. A clean container unit may also be used to serve snack items often available to guests such as peanuts, popcorn and other snack mixes.

It is important to note that inventive methods may comprise any of the following steps: establishing a restaurant (as by constructing it, hiring employees, obtaining necessary licenses, etc.), providing access to the restaurant to dining patrons (as by opening the restaurant), serving a patron at the dining table (as by bringing food to the table or by allowing the patron to obtain food elsewhere within the restaurant and bring it to the table himself or herself), providing a dining experience to a dining patron (as by allowing the patron to eat food prepared at the restaurant, and perhaps also by waiting on the diner), and permitting the dining patron to complete the dining experience.

Yet another function of the present invention may be its use in advertising for restaurants by modeling the containers to use the restaurant's logo (or other restaurant specific advertising indicia), such as a red lobster container for Red Lobster® Restaurants. The containers may be given or sold to customers as a visual reminder to return to the restaurant.

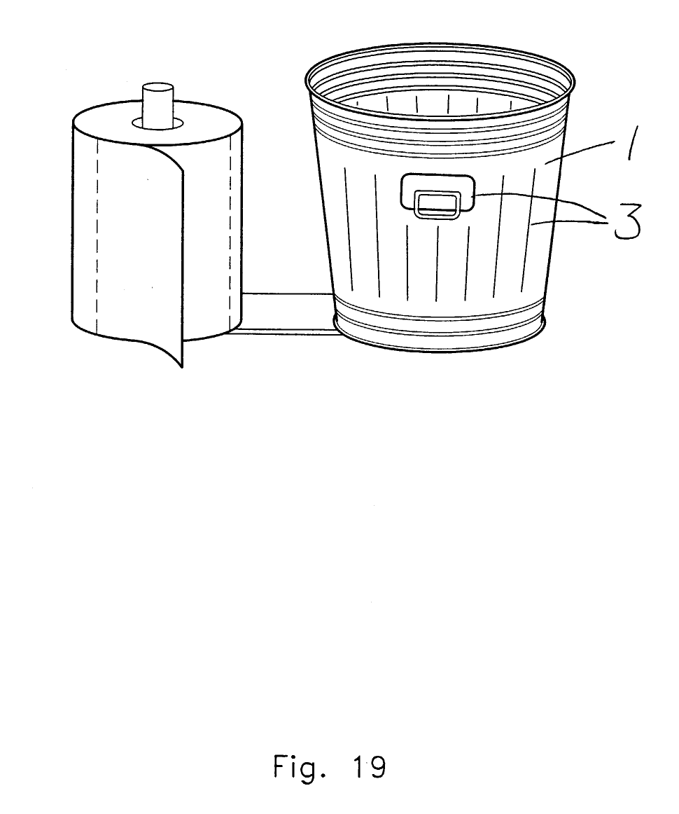

In addition, it should be understood that items may be combined with a container to provide enhanced functionality for the user. For example, as shown in FIG. 19, a small roll of paper towels (at type of paper towel assembly) or the like might be combined in a unitary or separate item. A sealed wet wipe container or the like could similarly be provided.

As can be easily understood from the foregoing, the basic concepts of the present invention may be embodied in a variety of ways. It involves both practical and decorative aspects as well as devices to accomplish the appropriate advertising, serving, handling and disposal of food and other items. In this application, the techniques are disclosed as part of the results shown to be achieved by the various devices described and as steps which are inherent to utilization. They are simply the natural result of utilizing the devices as intended and described. In addition, while some devices are disclosed, it should be understood that these not only accomplish certain methods but also can be varied in a number of ways. Importantly, as to all of the foregoing, all of these facets should be understood to be encompassed by this disclosure.

The discussion included in this application is intended to serve as a basic description. The reader should be aware that the specific discussion may not explicitly describe all embodiments possible; many alternatives are implicit. It also may not fully explain the generic nature of the invention and may not explicitly show how each feature or element can actually be representative of a broader function or of a great variety of alternative or equivalent elements. Again, these are implicitly included in this disclosure. Where the invention is described in device-oriented terminology, each element of the device implicitly performs a function. Apparatus claims may not only be included for the device described, but also method or process claims may be included to address the functions the invention and each element performs. Neither the description nor the terminology is intended to limit the scope of the claims which will be included in a full patent application.

It should also be understood that a variety of changes may be made without departing from the essence of the invention. Such changes are also implicitly included in the description. They still fall within the scope of this invention. A broad disclosure encompassing both the explicit embodiment(s) shown, the great variety of implicit alternative embodiments, and the broad methods or processes and the like are encompassed by this disclosure and may be relied upon by the claims for the full patent application. It should be understood that such language changes and broad claiming is accomplished in this nonprovisional filing. The non-provisional patent application may seek examination of as broad a base of claims as deemed within the applicant's right and will be designed to yield a patent covering numerous aspects of the invention both independently and as an overall system.

Further, each of the various elements of the invention and claims may also be achieved in a variety of manners. This disclosure should be understood to encompass each such variation, be it a variation of an embodiment of any apparatus embodiment, a method or process embodiment, or even merely a variation of any element of these. Particularly, it should be understood that as the disclosure relates to elements of the invention, the words for each element may be expressed by equivalent apparatus terms or method terms—even if only the function or result is the same. Such equivalent, broader, or even more generic terms should be considered to be encompassed in the description of each element or action. Such terms can be substituted where desired to make explicit the implicitly broad coverage to which this invention is entitled. As but one example, it should be understood that all actions may be expressed as a means for taking that action or as an element which causes that action. Similarly, each physical element disclosed should be understood to encompass a disclosure of the action which that physical element facilitates. Regarding this last aspect, as but one example, the disclosure of a “container” should be understood to encompass disclosure of the act of “containing”—whether explicitly discussed or not—and, conversely, were there effectively disclosure of the act of “containing”, such a disclosure should be understood to encompass disclosure of a “container” and even a “means for containing”. Such changes and alternative terms are to be understood to be explicitly included in the description.

In addition, as to each term used it should be understood that unless its utilization in this application is inconsistent with such interpretation, common dictionary definitions should be understood as incorporated for each term and all definitions, alternative terms, and synonyms such as contained in the Random House Webster's Unabridged Dictionary, second edition are hereby incorporated by reference. Finally, all references listed in the list of References To Be Incorporated By Reference In Accordance With The Nonprovisional Patent or other information statement filed with the application are hereby appended and hereby incorporated by reference, however, as to each of the above, to the extent that such information or statements incorporated by reference might be considered inconsistent with the patenting of this/these invention(s) such statements are expressly not to be considered as made by the applicant(s). Thus, the applicant(s) should be understood to claim at least: i) each of the container devices and systems as herein disclosed and described, ii) the related methods disclosed and described, iii) similar, equivalent, and even implicit variations of each of these devices and methods, iv) those alternative designs which accomplish each of the functions shown as are disclosed and described, v) those alternative designs and methods which accomplish each of the functions shown as are implicit to accomplish that which is disclosed and described, vi) each feature, component, and step shown as separate and independent inventions, vii) the applications enhanced by the various systems or components disclosed, viii) the resulting products produced by such systems or components, and ix) methods and apparatuses substantially as described hereinbefore and with reference to any of the accompanying examples, x) the various combinations and permutations of each of the elements disclosed, and xi) each potentially dependent claim or concept as a dependency on each and every one of the independent claims or concepts presented. Support should be understood to exist to the degree required under new matter laws—including but not limited to European Patent Convention Article 123(2) and United States Patent Law 35 USC 132 or other such laws—to permit the addition of any of the various dependencies or other elements presented under one independent claim or concept as dependencies or elements under any other independent claim or concept. Further, if or when used, the use of the transitional phrase “comprising” is used to maintain the “open-end” claims herein, according to traditional claim interpretation. Thus, unless the context requires otherwise, it should be understood that the term “comprise” or variations such as “comprises” or “comprising”, are intended to imply the inclusion of a stated element or step or group of elements or steps but not the exclusion of any other element or step or group of elements or steps. Such terms should be interpreted in their most expansive form so as to afford the applicant the broadest coverage legally permissible.

Any claims set forth at any time are hereby incorporated by reference as part of this description of the invention, and the applicant expressly reserves the right to use all of or a portion of such incorporated content of such claims as additional description to support any of or all of the claims or any element or component thereof, and the applicant further expressly reserves the right to move any portion of or all of the incorporated content of such claims or any element or component thereof from the description into the claims or vice-versa as necessary to define the matter for which protection is sought by this application or by any subsequent continuation, division, or continuation-in-part application thereof, or to obtain any benefit of, reduction in fees pursuant to, or to comply with the patent laws, rules, or regulations of any country or treaty, and such content incorporated by reference shall survive during the entire pendency of this application including any subsequent continuation, division, or continuation-in-part application thereof or any reissue or extension thereon.

1. A method of maintaining dining area cleanliness comprising the steps of:
obtaining a container adapted to contain unwanted dining items;
establishing said container atop a dining table before a diner eats at said dining table; and
discarding said unwanted dining items,
wherein said method improves dining area sanitation and reduces dining area clean-up time.

2. A method of maintaining dining area cleanliness as in claim 1 wherein said unwanted dining items comprise foodstuff packaging waste.

3. A method of maintaining dining area cleanliness as in claim 1 wherein said unwanted dining items comprise unconsumed foods.

4. A method of maintaining dining area cleanliness as in claim 1 wherein said unwanted dining items comprise left-over foods.

5. A method of maintaining dining area cleanliness as described in claim 1 wherein said enclosable container has expressive indicia.

6. The container of claim 5.

7. A method of maintaining dining area cleanliness as described in claim 5 wherein said expressive indicia relates to at least one subject selected from the group of subjects consisting of: food type, geographic site, season, holiday, event, amusement facility, business logo, sport, and specific business entity.

8. A method of maintaining dining area cleanliness as described in claim 5 wherein said expressive indicia comprises shaping and marking that give said enclosable container the appearance of a sports ball.

9. The container of claim 8.

10. A method of maintaining dining area cleanliness as described in claim 5 wherein said expressive indicia comprises shaping and marking that give said enclosable container a dumpster or trashcan appearance.

11. A method of maintaining dining area cleanliness as described in claim 5 wherein said expressive indicia comprises advertising indicia.

12 A method of maintaining dining area cleanliness as described in claim 11 wherein said advertising indicia comprises restaurant promotion indicia.

13. A method of maintaining dining area cleanliness as described in claim 1 wherein said step of discarding said unwanted food items comprises the step of discarding said container.

14. A method of maintaining dining area cleanliness as described in claim 1 wherein said dining area is a restaurant and said steps of obtaining, establishing and discarding are performed by said restaurant.

15. A method of maintaining dining area cleanliness as described in claim 1 further comprising the step of establishing a paper towel assembly in propinquity with the placement of said container atop said dining table.

16. A method of maintaining dining area cleanliness as described in claim 1 wherein said step of obtaining a container adapted to contain unwanted dining items comprises the step of obtaining an enclosable container and an upper enclosure element engageable with said enclosable container.

17. A method of facilitating a diner's transportation of foodstuffs from a restaurant comprising the steps of:
obtaining a container to contain said foodstuffs; and
establishing said container atop a dining table before said diner eats at said dining table,
wherein said steps of obtaining a container and establishing said container are performed by said restaurant.

18. A method of facilitating a diner's transportation of foodstuffs from a restaurant as described in claim 17 wherein said container comprises an enclosable container and an upper enclosure element engageable with said enclosable container.

19. A method of facilitating a diner's transportation of foodstuffs from a restaurant as described in claim 17 further comprising the step of unconditionally releasing with said diner and from said restaurant said container.

20. A method of facilitating a diner's transportation of foodstuffs from a restaurant as described in claim 17 wherein said container has expressive indicia.

21. The container of claim 20.

22. A method of facilitating a diner's transportation of foodstuffs from a restaurant as described in claim 20 wherein said expressive indicia comprises advertising indicia.

23. A method of facilitating a diner's transportation of foodstuffs from a restaurant as described in claim 22 wherein said advertising indicia comprises restaurant promotion indicia.

24. A method of facilitating a diner's transportation of foodstuffs from a restaurant as described in claim 20 wherein said expressive indicia comprises shaping and marking that give said enclosable container the appearance of a sports ball.

25. A method of facilitating a diner's transportation of foodstuffs from a restaurant as described in claim 20 wherein said expressive indicia comprises shaping and marking that give said enclosable container a dumpster or trashcan appearance.

26. A method of facilitating a diner's transportation of foodstuffs from a restaurant as described in claim 17 further comprising the step of indicating a foodstuff containment and transportation function achievable by of said container.

27. A method of facilitating a diner's transportation of foodstuffs from a restaurant as described in claim 17 further comprising the step of establishing a paper towel assembly in propinquity with the placement of said enclosable container atop said dining table.

28. A restaurant method comprising the steps of:
establishing a restaurant;
providing access to said restaurant to dining patrons;
unconditionally providing at least one enclosable container and at least one engageable upper enclosure element to at least one of said dining patrons before said at least one dining patron sits at a dining table at said restaurant;
serving food to said at least one dining patron;
providing a dining experience to said at least one dining patron;
permitting said at least one dining patron to complete said dining experience; and
unconditionally releasing with said at least one dining patron and from said restaurant said at least one enclosable container and said at least one engageable upper enclosure element,
wherein said at least one enclosable container has expressive indicia, and
wherein said step of unconditionally releasing with said at least one dining patron and from said restaurant said at least one enclosable container and said at least one engageable upper enclosure element is performed after said step of permitting said at least one dining patron to complete said dining experience.

29. A restaurant method as described in claim 28 wherein said step of unconditionally providing at least one enclosable container and at least one engageable upper enclosure element to at least one of said dining patrons comprises the step of by establishing said at least one enclosable container and said at least one engageable upper enclosure element atop said dining table.

30. A restaurant method as described in claim 28 wherein said expressive indicia comprises advertising indicia.

31. A restaurant method as described in claim 28 wherein said expressive indicia indicates an intended use of said at least one enclosable container and said at least one engageable upper enclosure element.
